(19) United States
(12) Patent Application Publication
(10) Pub. No.: US 2016/0150078 A1
(43) Pub. Date: May 26, 2016

(54) COMMUNICATION SYSTEMS AND METHODS

(71) Applicant: Netincent, Inc., Saratoga, CA (US)

(72) Inventors: Sunil Pradeep Joshi, Saratoga, CA (US); Kalyan V. Krishnan, Fremont, CA (US)

(21) Appl. No.: 14/952,541

(22) Filed: Nov. 25, 2015

Related U.S. Application Data
(60) Provisional application No. 62/085,239, filed on Nov. 26, 2014.
(60) Provisional application No. 62/097,533, filed on Dec. 29, 2014.

(51) Int. Cl. H04M 3/42; H04W 4/14; G06Q 30/02; G06Q 20/32; G06Q 20/40; H04W 4/16; H04W 4/20

(52) U.S. Cl. CPC H04M 3/42068; H04W 4/16; H04W 4/14; H04W 4/206; G06Q 20/3255; G06Q 20/401; G06Q 30/0222

(57) ABSTRACT

Example communication systems and methods are described. In one implementation, a method receives a first message from a user and extracts a user identity and a transaction request. An alias identity is assigned to the user identity. A second message is transmitted to a merchant device in which the second message includes the alias identity and the transaction request. The method receives a third message from the merchant device and extracts the alias identity and a transaction completion confirmation from the third message. A fourth message, which includes the transaction completion confirmation, is communicated to the user based on the user identity.

### RELATED APPLICATION

This application claims the priority benefit of U.S. Provisional Application Ser. No. 62/097,533, entitled “SMS BASED ARCHITECTURE, LANGUAGE AND MECHANISMS FOR FINANCIAL TRANSACTIONS”, filed Dec. 29, 2014, and claims the priority benefit of U.S. Provisional Application Ser. No. 62/085,239, entitled “SINGLE-USE TRACKABLE TOKENS FOR USE BETWEEN MERCHANTS AND CUSTOMERS”, filed Nov. 26, 2014, the disclosures of which are incorporated by reference herein in their entirety.

### TECHNICAL FIELD

The present disclosure relates to data communication systems and methods that implement, for example, a service that facilitates SMS-based transactions between two parties.

### BACKGROUND

In today's connected world, most people have access to mobile devices such as mobile phones and tablets. While the Short Message Service, or SMS (also known as “texting”), is a ubiquitous feature of most mobile phones today, an increasing number of mobile phones also offer data connectivity, with data connectivity methods that include 3G, 4G/LTE and Wi-Fi. There exist, however, some mobile phone users who do not have access to data connectivity features on their mobile phones. In some cases, such users do not possess a mobile phone that has a data connectivity feature, while other users might not be able to afford data plans on their mobile phones. Yet another set of users may feel technically challenged to use the data connectivity features on their mobile phones. Due to this lack of data connectivity, this class of users who do not use the data connectivity features on their mobile phones is limited to using SMS-based connectivity methods and may not be able to avail of, for example, transaction methods such as rewards programs that require data connectivity on mobile phones for their implementation. Thus, there exists a need for a system that provides an SMS-based transaction capability to account for the set of users who are limited to using SMS-based communication methods on their mobile phones.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment of an environment that includes a single customer and a single merchant associated with a transaction that uses a communication engine.

FIG. 2 is a block diagram depicting an embodiment of an environment that includes multiple customers and multiple merchants associated with multiple independent transactions that use a communication engine.

FIG. 3 is a block diagram depicting an embodiment of an environment that includes a communication engine implemented in a cloud computing environment.

FIG. 4 is a block diagram depicting an embodiment of an architecture of a merchant device.

FIG. 5 is a block diagram depicting an embodiment of an architecture of a customer device.

FIG. 6 is a block diagram depicting an embodiment of a communication engine.

FIGS. 7A and 7B represent a flow diagram depicting an embodiment of a method for handling a transaction between a customer and a merchant.

FIG. 8A is a block diagram depicting an embodiment of an environment that includes a single customer and a single merchant associated with a transaction that manages a physical token given to the customer by the merchant.

FIG. 8B represents a flow diagram depicting an embodiment of a method for managing tokens as a part of a rewards program.

FIG. 9A is a diagram depicting example SMS message structures and syntax used to communicate with a communication engine.

FIG. 9B represents a flow diagram depicting an embodiment of a method for processing messages received by a communication engine.

FIG. 10 is a diagram presenting example SMS-based interactions between a communication engine and a customer, and between the communication engine and a merchant.

FIG. 11 is a block diagram that depicts a generalized processing architecture that can be used to implement the communication engine and other systems and components discussed herein.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein describe an SMS-based service that provides an SMS-based transaction capability between two or more parties, wherein the SMS-based service functions to communicate data between the two or more parties. Some embodiments of the systems and methods described herein may implement the SMS-based service in a cloud computing environment, for example. The SMS-based transactions between the two or more parties include, but are not limited to, customer rewards programs, wherein one party in the SMS-based transaction may be a customer and another party in the SMS-based transaction may be a merchant. The transactions associated with the customer rewards programs may include, for example, customer loyalty rewards and frequent shopper rewards. These transactions may be either financial transactions, or the transactions may be associated with other kinds of rewards such as frequent shopper points or frequent flyer miles, as described herein. Customer rewards programs as implemented by the SMS-based transaction system allow for both the rewarding of customer rewards by the merchant and for the redemption of customer rewards by the customer. Maintaining the privacy associated with the identities of the two or more parties involved in the SMS-based transactions is one of the advantages offered by the SMS-based service described herein.

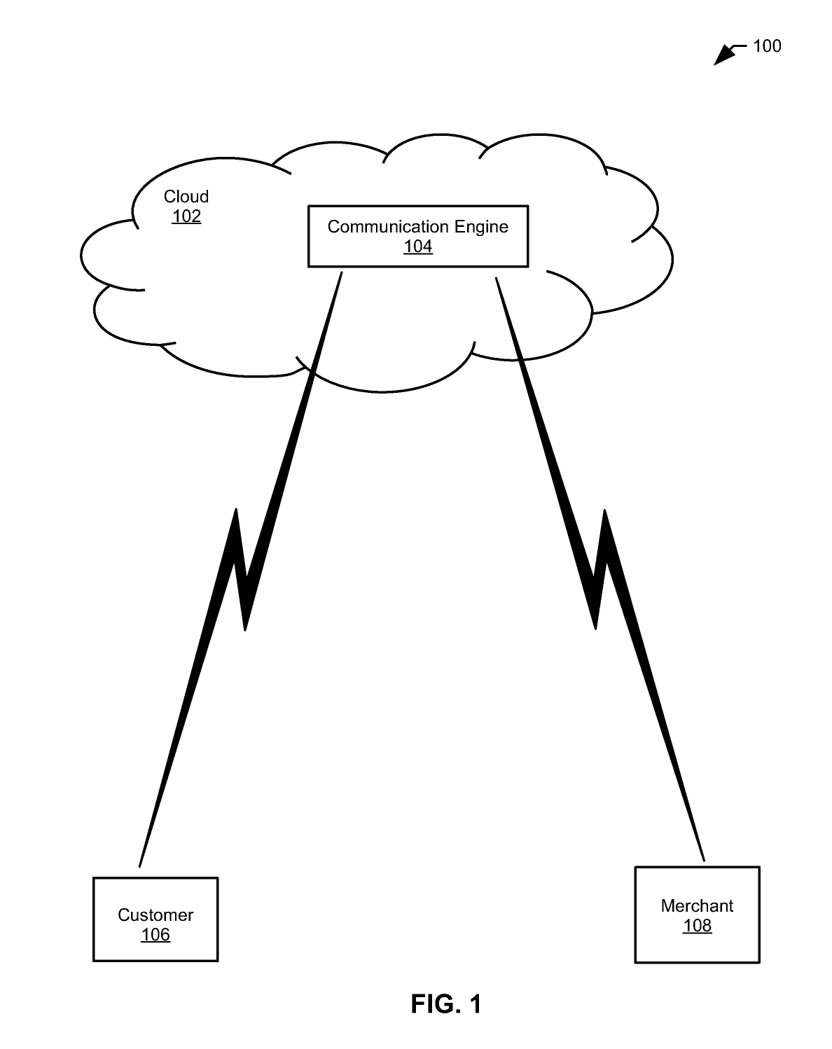

FIG. 1 is a block diagram 100 depicting an embodiment of an environment that includes a single customer and a single merchant associated with a transaction that uses a communication engine. In one embodiment, a communication engine 104 is located in cloud 102, wherein the term “cloud” is used to refer to, for example, cloud computing and cloud storage systems. In this embodiment, a customer 106 communicates with communication engine 104. A merchant 108 also communicates with communication engine 104. In some embodiments, communication between the customer 106 and the communication engine 104 may include methods such as SMS, Wi-Fi, Internet connectivity, 3G, 4G, or any combinations of these or other communication methods. In other embodiments, communication between the merchant 108 and the communication engine 104 may include methods such as SMS, Wi-Fi, Internet connectivity, 3G, 4G, or any combinations of these or other communication methods.

In some embodiments, communication engine 104 acts as an intermediate communication device between customer 106 and merchant 108, wherein a message to be transmitted from the customer 106 to the merchant 108 is first sent from the customer 106 to the communication engine 104, and the communication engine 104 transmits this message to the merchant 108. In other embodiments, communication engine 104 acts as an intermediate communication device between merchant 108 and customer 106, wherein a message to be transmitted from the merchant 108 to the customer 106 is first sent from the merchant 108 to the communication engine 104, and the communication engine 104 transmits this message to the customer 106. In some embodiments, communication engine 104 can also directly communicate independently with the customer 106 and with the merchant 108.

In some embodiments, the method of communication between the customer 106 and the communication engine 104 may be different from the method of communication between the merchant 108 and the communication engine 104. For example, the customer 106 may communicate with the communication engine using an SMS-based protocol, while the merchant 108 may communicate with the communication engine 104 using a 4G/LTE connection. The communication engine 104 accounts for and compensates for these asymmetries in communication methods. In this example, if the customer 106 wishes to send a message to the merchant 108 via the communication engine 104, the communication engine 104 translates the SMS message received from the customer 106 into an appropriate format for transmission to the merchant 108 via the 4G/LTE communication link.

One advantage of using the communication engine 104 as an intermediate communication device as described above is that it ensures the privacy of both customer 106 and merchant 108. Communication engine 104 stores the identities of both the customer 106 and the merchant 108. In some embodiments, communication engine 104 does not share the identity of customer 106 with merchant 108, or the identity of merchant 108 with customer 106. In this case, the identities of both the customer 106 and the customer 108 are protected. In other embodiments, communication engine 104 may share certain aspects of the identity of customer 106 with merchant 108 that include, but are not limited to, account number, customer frequent shopper tier status (for example, gold, silver or bronze) and so on, while other information associated with the identity of customer 106, such as the customer's mobile phone number, the customer's email address and so on, are kept private and are not shared by communication engine 104 with merchant 108. In still other embodiments, communication engine 104 may share certain aspects of information related to the merchant 108 with customer 106, such as the merchant's name, address and business and phone number, and so on, while other information associated with the identity of merchant 108, such as the merchant's mobile phone number, are kept private and are not shared by communication engine 104 with customer 106. Before initiating a transaction, both the customer 106 and the merchant 108 need to be independently registered with the communication engine 104. The identity of the communication engine 104 is known to both the customer 106 and the merchant 108, and this allows two-way communication between the communication engine 104 and the customer 106, and the communication engine 104 and the merchant 108.

In some embodiments, the customer 106 and the merchant 108 may be engaged in a financial transaction via the communication engine 104, where the financial transaction includes, but is not limited to, cash back rewards associated with a customer rewards program. In other embodiments, the transaction between the customer 106 and the merchant 108 may be a non-financial transaction. For example, the customer 106 may wish to provide anonymous feedback to the merchant 108 regarding the quality of customer service. This anonymous feedback could include a customer complaint. A help request from customer 106 to merchant 108 could also be handled by communication engine 104. A whistleblower program could also avail of the anonymity provided by the communication engine 104, wherein a whistleblower can be assigned the role of the customer 106 for example, and the merchant 108 can, for example, correspond to the authority administering the whistleblower program.

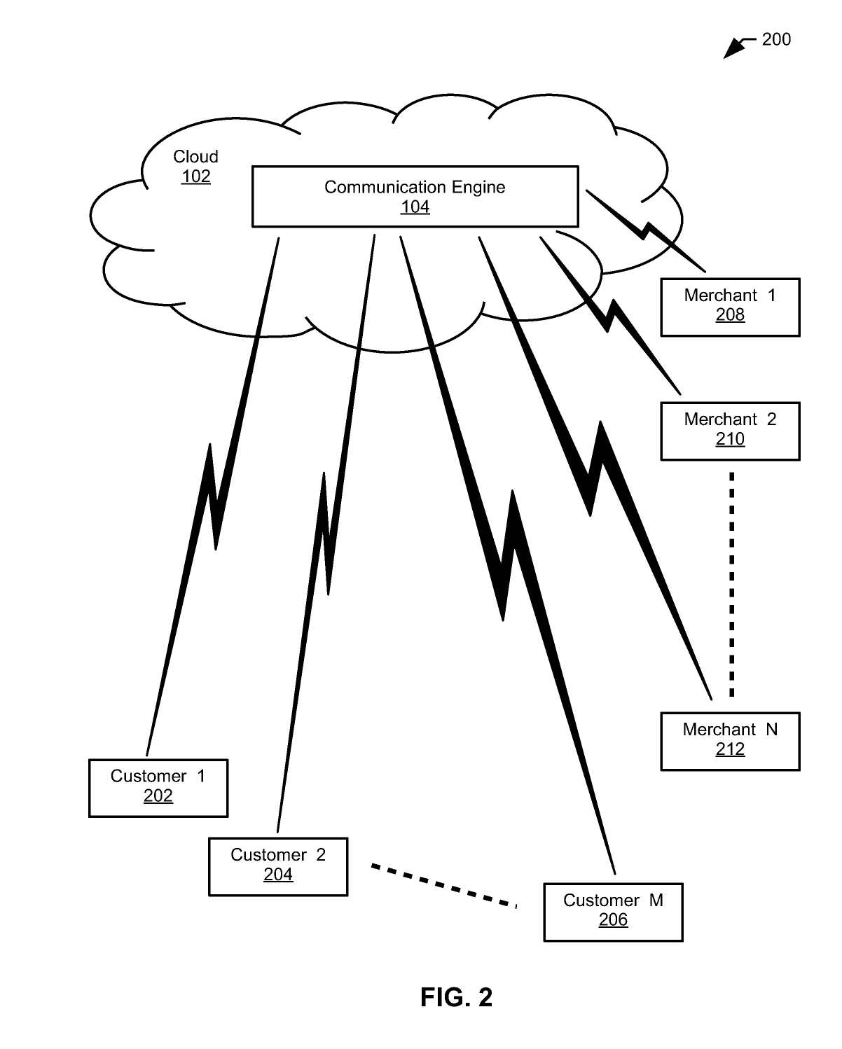

FIG. 2 is a block diagram 200 depicting an embodiment of an environment that includes multiple customers and multiple merchants associated with multiple independent transactions that use a communication engine . In one embodiment, customers 202, 204, and 206 independently communicate with communication engine 104 located in cloud 102. In this embodiment, merchants 208, 210, and 212 independently communicate with communication engine 104. In some embodiments, the number of customers, M, is greater than the number of merchants, N. Communication engine 104 stores the identities of all M customers and N merchants, and communicates messages from customers or merchants to merchants or customers respectively, thereby protecting the privacy of the customers and merchants as described earlier in this specification. All customers and all merchants have individual identities that are stored on the communication engine 104. All communication between the customer and the merchant is handled by the communication engine 104. In some embodiments, the communication links can be any combination of SMS, Wi-Fi, 3G, 4G/LTE, or any other communication protocol.

In some embodiments, the identity of a customer, for example customer 202, corresponds to the customer's mobile phone number. Other unique customer identifiers that can be used include but are not limited to the customer's social security number, an email address corresponding to the customer, any of the customer's social network handles (for example, as on Facebook or Twitter), or any combinations of these. In other embodiments, the identity of a merchant, for example merchant 208, corresponds to the merchant's mobile phone number. In other embodiments, the identity of the merchant is the merchant's landline number. In still other embodiments, each merchant can be given an identifier that comprises an alphanumeric symbol that may be an abbreviation of the merchant's name. For example, a generalized four-character alphanumeric symbol comprised of a combination selected from the set of letters a through z and the numbers 0 through 9 gives a namespace with over 1.5 million unique merchant identifiers, allowing a large number of merchants to be uniquely represented and identified by the communication engine 104. Using a four-character alphanumeric symbol also has the advantage of reducing the SMS text size for the customer, for example customer 202. In some embodiments, the merchant identifier can be a longer symbol string of alphanumeric characters (such as 6 or 7 alphanumeric characters), and this allows ease of reading and minimizes errors. Publicly posting merchant identifiers allows one to have a handle to address a merchant uniquely without compromising the privacy of their mobile phone number, for example.

It is important to note that the identity of a customer is not shared with a merchant and vice versa. Instead, an aliasing scheme described subsequently is implemented by the communication engine 104. This aliasing scheme allows the identities of both the customer and the merchant to be kept private.

In some embodiments, a customer may shop at different merchants at different times. In other embodiments, multiple customers may communicate with multiple merchants simultaneously via the communication engine 104. For example, an event that involves a presentation to an audience by multiple presenters, wherein the members of the audience wish to communicate with the presenters while keeping the identities of both parties anonymous, can be implemented by using the communication engine 104 as an intermediate communication device, wherein the members of the audience correspond to the “customers” and the presenters correspond to the “merchants.”

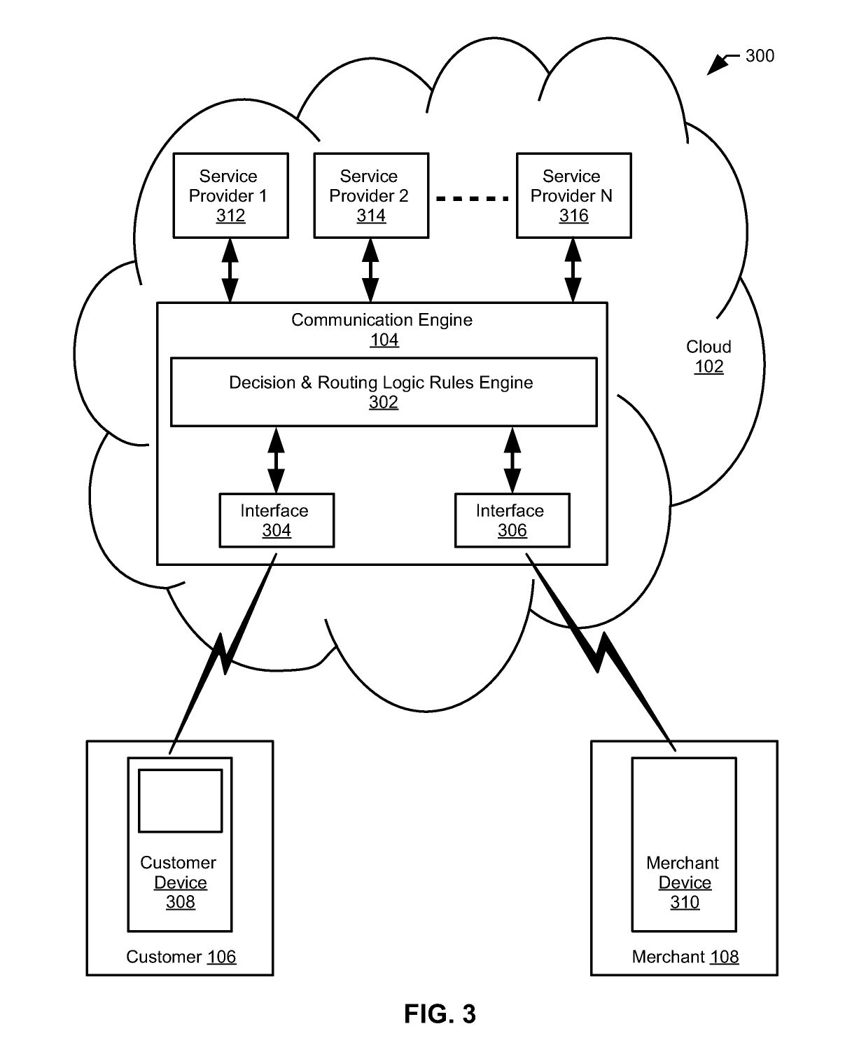

FIG. 3 is a block diagram 300 depicting an embodiment of an environment that includes a communication engine as implemented in a cloud computing environment. In this embodiment, communication engine 104, as implemented in cloud 102, comprises a decision and routing logic rules engine 302, an interface 304 and an interface 306. The decision and routing logic rules engine 302 is responsible for implementing the core functionality of the communication engine 104. In some embodiments, the decision and routing logic rules engine 302 is responsible for sending and receiving messages, and is also responsible for routing messages to the intended recipients. In other embodiments, the decision and routing logic rules engine 302 makes a determination of what information is appropriate to send across which interfaces to complete the requested transactions.

The decision and routing logic rules engine 302 is also interfaced with interface 304. Interface 304 serves as an interface between the decision and routing logic rules engine 302 and a customer device 308 associated with customer 106. The decision and routing logic rules engine 302 is also interfaced with interface 306. Interface 306 serves as an interface between the decision and routing logic rules engine 302 and a merchant device 310 associated with merchant 108. In some embodiments, customer device 308 may be a laptop computer, desktop computer, a mobile device, a tablet computer or any other computing device capable of connecting to a public network such as the Internet. In other embodiments, customer device 308 is a mobile phone with one or more methods of connectivity that include but are not limited to SMS, Wi-Fi, 3G, 4G/LTE and Bluetooth. In some embodiments, merchant device 310 may a laptop computer, desktop computer, a mobile device, a tablet computer or any other computing device capable of connecting to a public network such as the Internet. In other embodiments, merchant device 310 is a mobile phone with one or more methods of connectivity that include but are not limited to SMS, Wi-Fi, 3G, 4G/LTE and Bluetooth. In some embodiments, customer device 308 may run a software application that allows the customer device 308 to communicate with communication engine 104. In some embodiments, merchant device 310 may run a software application that allows the merchant device 310 to communicate with communication engine 104.

In some embodiments, communication engine 104 is independently interfaced with service providers 312, 314, and 316, wherein service providers 312, 314, and 316 are located in the cloud 102. In some embodiments, a service provider may be, for example, a bank or a financial institution, a credit card company, an airline frequent flier program, or any other entity that provides online services. The communication engine 104 may use one or more service providers such as service providers 312, 314, and 316 to provide services that include but are not limited to cash back, cash back rewards, credit card points, airline mileage, reward points and so on. Service providers 312, 314 and 316 may also be telecommunications companies (for example, AT&T and Verizon), or other internet and cloud-based companies, such as Google and Facebook, that provide advertising and other services. In other embodiments, communication engine 104 may be associated with offering multiple services that include, but are not limited to, cash back rewards, coupons, messaging capabilities and so on. These services could be offered either to customer 106, to merchant 108, or to both. In some embodiments, merchant 108 might support multiple services simultaneously. In other embodiments, the services offered by communication engine may differ depending on the customer 106 and the merchant 108.

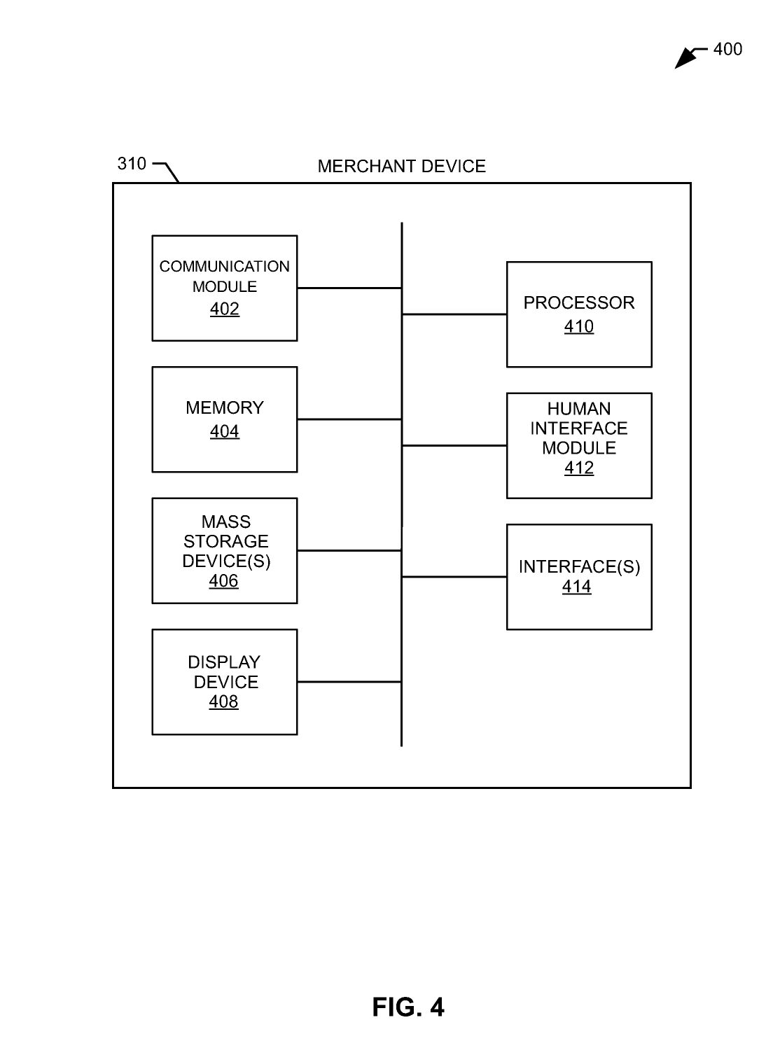

FIG. 4 is a block diagram 400 depicting an embodiment of an architecture of merchant device 310. In some embodiments, merchant device 310 may include a communication module 402 that allows the merchant device 310 to communicate with other external devices by methods that include communication via the Internet, SMS, 3G, 4G/LTE or other methods. A memory 404 includes, but is not limited to, any combination of random access memory (RAM), read-only memory (ROM) and flash memory, is used to store data required by the merchant device 310. Mass storage device(s) 406, which may be a hard disk drive, is used for data storage. A display device 408 may include a device such an LCD display or an OLED display for presenting a user interface and other information to a user of the merchant device 310. Merchant device 310 may also include a processor 410, and a human interface module 412. Processor 410 performs any number of operations and activities, such as those discussed herein. Human interface module 412 may include human interface methods including but not limited to audio-visual signals, haptic feedback, touchscreen input, voice commands and so on. Interface(s) 414 is used to interface with one or more external devices.

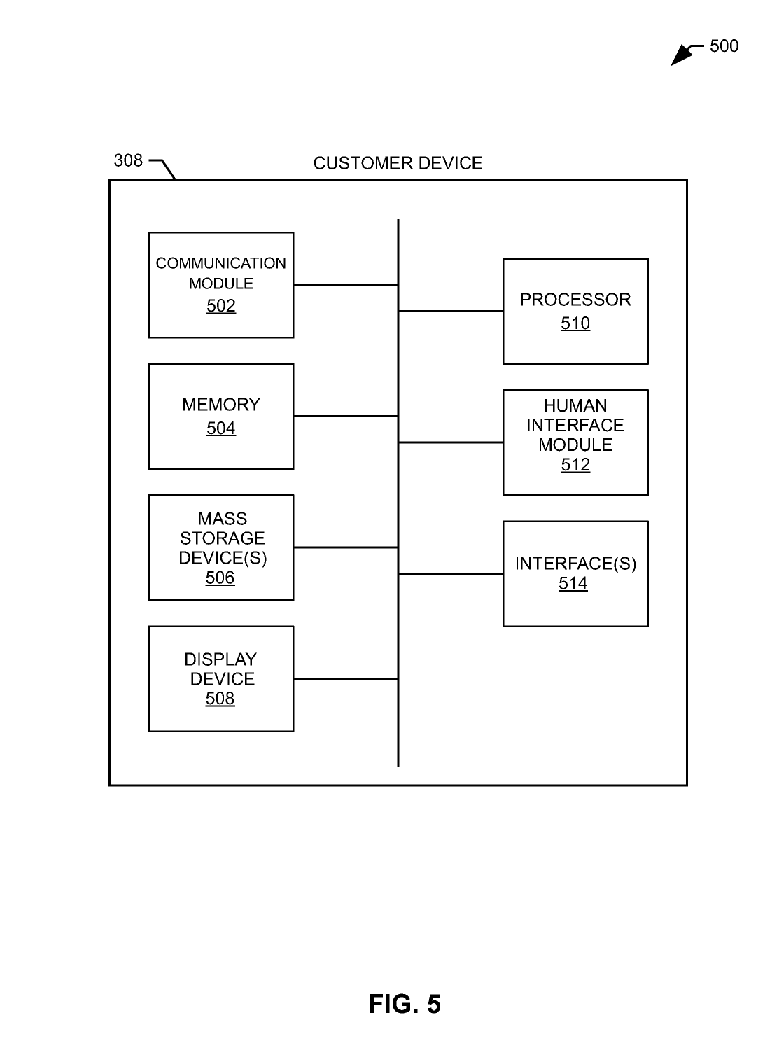

FIG. 5 is a block diagram 500 depicting an embodiment of an architecture of customer device 308. In some embodiments, customer device 308 may include a communication module 502 that allows the customer device 308 to communicate with other external devices by methods that include communication via the Internet, SMS, 3G, 4G/LTE or other methods. A memory 504 includes, but is not limited to, any combination of random access memory (RAM), read-only memory (ROM) and flash memory, is used to store data required by the customer device 308. Mass storage device(s) 506, which may be a hard disk drive, is used for data storage. A display device 508 may include a device such an LCD display or an OLED display for presenting a user interface and other information to a user of the customer device 308. Customer device 308 may also include a processor 510, and a human interface module 512. Processor 510 performs any number of operations and activities, such as those discussed herein. Human interface module 512 may include human interface methods including but not limited to audio-visual signals, haptic feedback, touchscreen input, voice commands and so on. Interface(s) 514 is used to interface with one or more external devices.

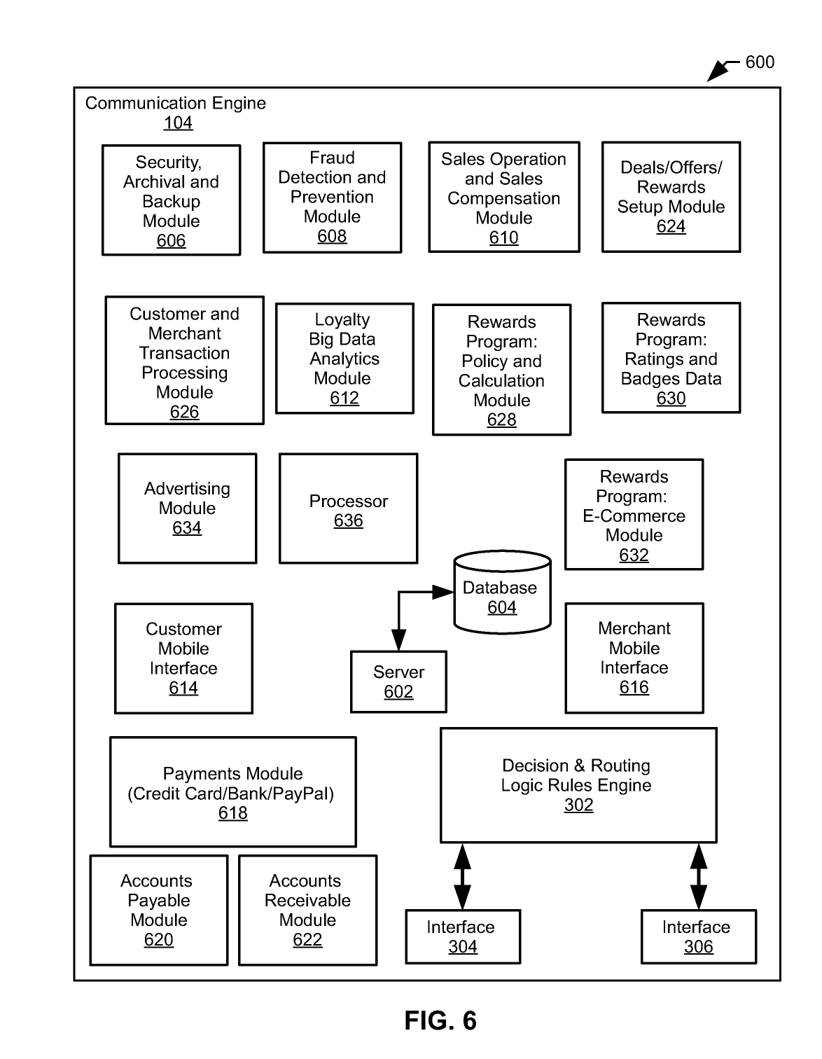

FIG. 6 is a block diagram 600 depicting an embodiment of a communication engine. In some embodiments, communication engine 104 includes decision and routing logic rules engine 302, interface 304 and interface 306. The decision and routing logic rules engine 302 is responsible for sending and receiving messages, and is also responsible for routing messages to the intended recipients. The decision and routing logic rules engine 302 is also interfaced with interface 304. Interface 304 serves as an interface between the decision and routing logic rules engine 302 and a customer device 308 associated with customer 106. The decision and routing logic rules engine 302 is also interfaced with interface 306. Interface 306 serves as an interface between the decision and routing logic rules engine 302 and a merchant device 310 associated with merchant 108. Communication engine 104 also includes a customer mobile interface 614 and a merchant mobile interface 616. In the event that the customer device 308 is a mobile device, customer mobile interface 614 is used to communicate with the customer device 308. In the event that the merchant device 310 is a mobile device, merchant mobile interface 616 is used to communicate with the merchant device 310.

Communication engine 104 may also include a server 602 and a database 604. Server 602 is used by the communication engine to interface with, for example, cloud 102. Database 604 may be used to store, for example, customer data which includes the customer identity and customer account information. Database 604 may also be used to store merchant data which includes the merchant identity and merchant account information. Communication engine 104 may also include a security, archival and backup module 606 which is responsible for implementing security features such as encryption. Security, archival and backup module 606 also performs the functions of archiving and backing up data. A fraud detection and prevention module 608 intercepts and prevents any fraudulent or similar activities. In some embodiments, fraud detection and prevention module 608 may post-process completed transactions to look for suspicious patterns of transactions with a fraud signature. A sales operation and sales compensation module 610 is associated with coordinating sales operations and the corresponding sales compensation. A deals/offers/rewards setup module 624 is used to implement or update any existing deals, offers and/or rewards offered by one or more merchants at any point in time. A customer and merchant transaction processing module 626 performs the tasks of processing any customer-merchant transactions including, for example, cash back rewards issuance and cash back rewards redemption.

A loyalty big data analytics module 612 is associated with customer loyalty and shopping habits based on analyzing big data associated with customer-merchant interactions and transactions. In some embodiments, big data analytics module 612 analyzes individual and collective shopping transactions of one or more customers and derives inferences and information that can be used in a predictive way to incent or entice these or other shoppers by bringing to them just the kinds of offers that are likely to result in a higher probability of the desired outcome. In other words, the loyalty big data analytics module 612 can become a learning engine that adaptively gets better with its recommendations. A rewards program: policy and calculation module 628 is used to implement policies and calculate parameters associated with the rewards program. A rewards program: ratings and badges data 630 is associated, for example, with different tiers or badges associated with a customer rewards program. An advertising module 634 is used for generating advertisements and promotional online materials. A rewards program: e-commerce module 632 performs the function of coordinating e-commerce transactions pertaining to, for example, a customer rewards program. A payments module (credit card/bank/PayPal) 618, along with an accounts payable module 620 and an accounts receivable module 622 are associated with financial transactions, both for sending and receiving any kind of currency. Additionally, a processor 636 performs any number of operations and activities, such as those discussed herein.

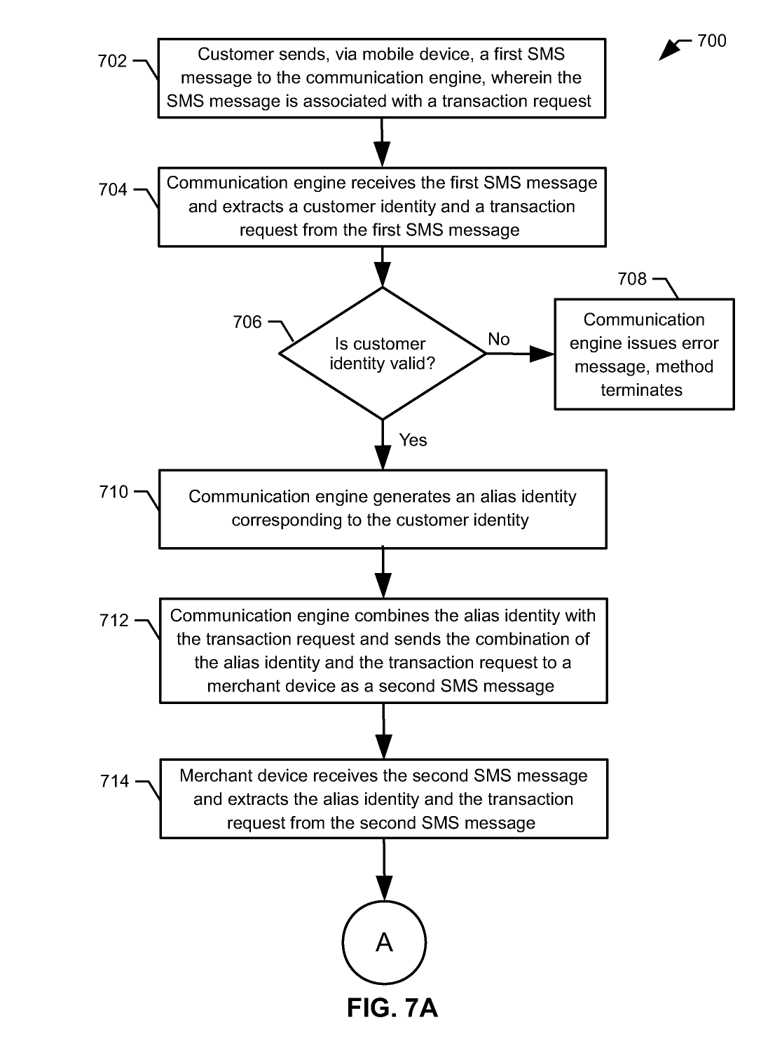

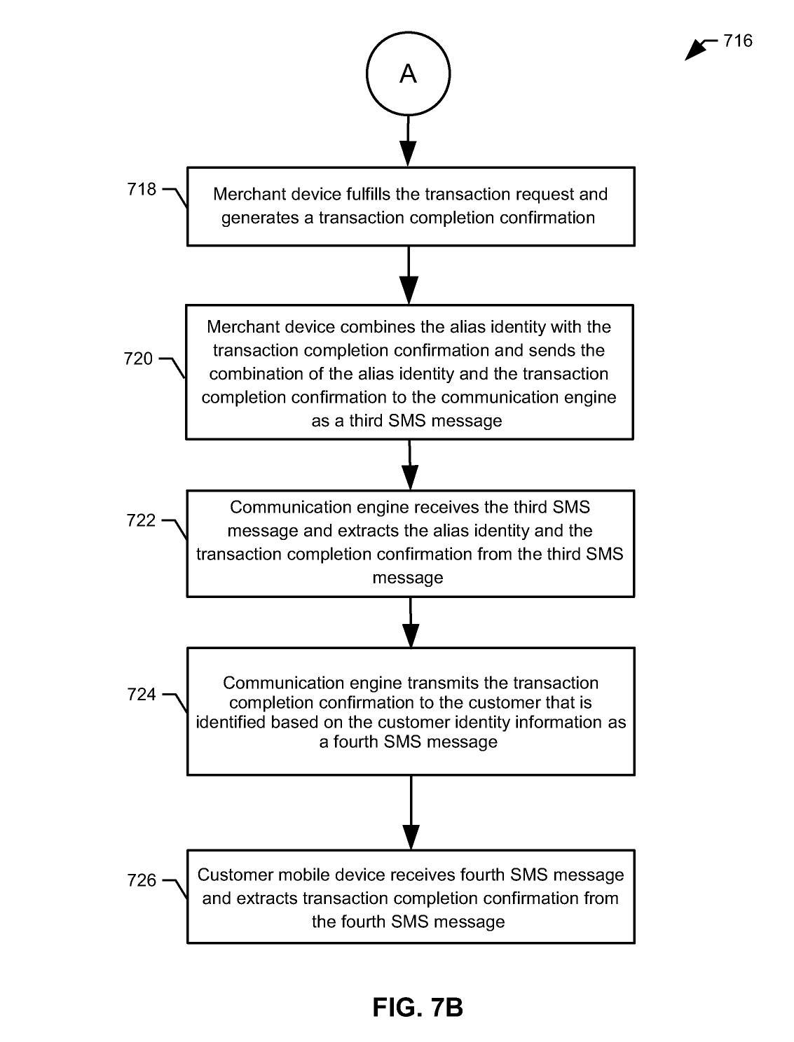

FIG. 7A represents a flow diagram depicting an embodiment of a method 700 for handling a transaction between a customer and a merchant. At 702, a customer sends, via a mobile device, a first SMS message to the communication engine, wherein the first SMS message is associated with a transaction request. At 704, the communication engine receives the first SMS message and extracts a customer identity and a transaction request from the first SMS message. At 706, the method checks to see if the customer identity is valid. The customer identity could be, for example, the customer's mobile phone number. A list of valid customer identities is stored in, for example, database 604. If the customer identity is not valid, the communication engine issues an error message to the customer and the method terminates at 708. At 710, the communication engine generates an alias identity corresponding to the customer identity. This alias identity is used to protect the privacy of the customer and to avoid having to give out the customer identity to a merchant, for example. At 712, the communication engine combines the alias identity with the transaction request and sends the combination of the alias identity and the transaction request to a merchant device as a second SMS message. At 714, the merchant device receives the second SMS message and extracts the alias identity and the transaction request from the second SMS message. The method then proceeds to A, with a continued description in FIG. 7B.

FIG. 7B represents a flow diagram 716 which is a continuation of the flow diagram of FIG. 7A. At A, the method continues from FIG. 7A and proceeds to 718, where the merchant device fulfills the transaction request and generates a transaction completion confirmation. Next, at 720, the merchant device combines the alias identity with the transaction completion confirmation and sends the combination of the alias identity and the transaction completion confirmation to the communication engine as a third SMS message. At 722, the communication engine receives the third SMS message and extracts the alias identity and the transaction completion confirmation from the third SMS message. Next, at 724, the communication engine transmits the transaction completion information to the customer that is identified based on the customer identity as a fourth SMS message. Finally, at 726, the customer mobile device receives the fourth SMS message and extracts the transaction completion confirmation from the fourth SMS message.

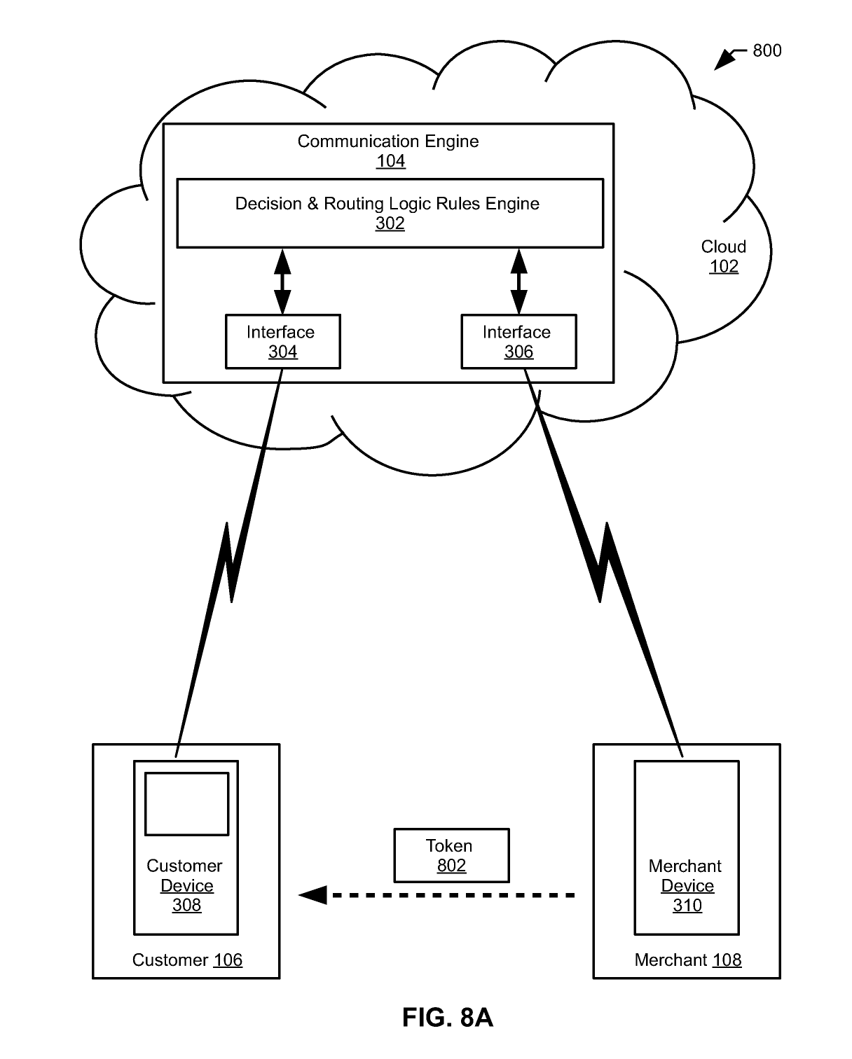

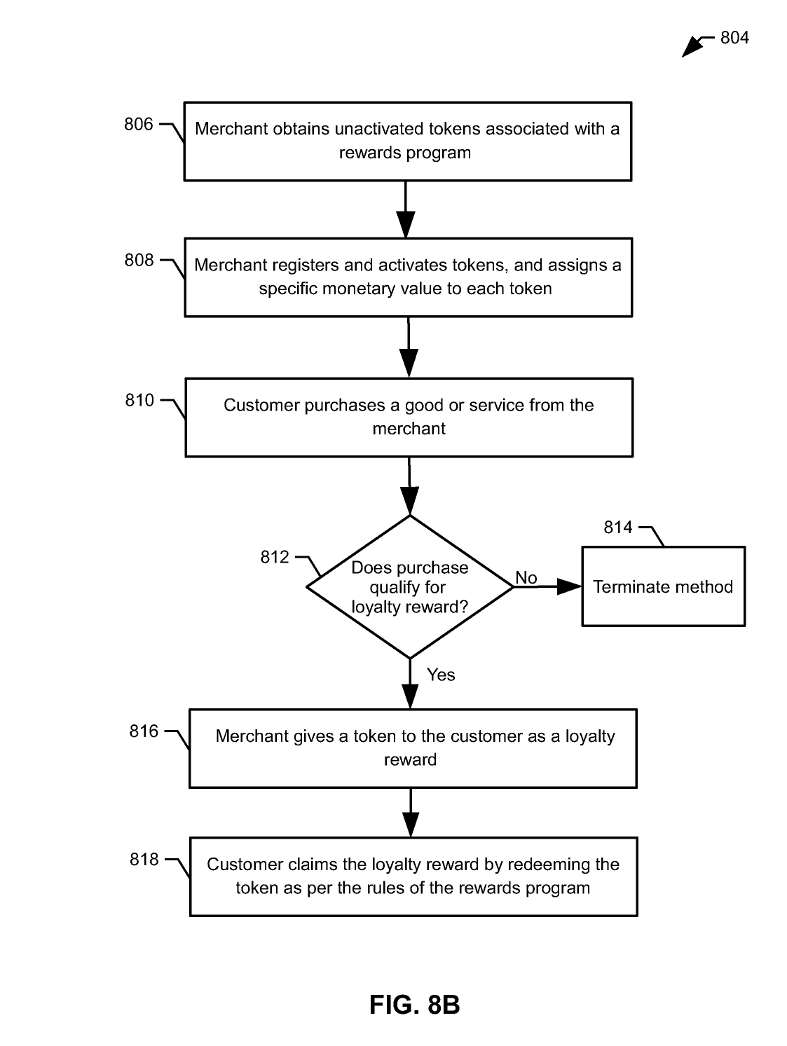

FIG. 8A is a block diagram 800 depicting an embodiment of an environment that includes a single customer and a single merchant associated with a transaction that manages a physical token given to the customer by the merchant. In this embodiment, communication engine 104, as implemented in cloud 102, comprises decision and routing logic rules engine 302, interface 304 and interface 306. The decision and routing logic rules engine 302 is responsible for implementing the core functionality of the communication engine 104. The decision and routing logic rules engine 302 is responsible for sending and receiving messages, and is also responsible for routing messages to the intended recipients. The decision and routing logic rules engine 302 is also interfaced with interface 304. Interface 304 serves as an interface between the decision and routing logic rules engine 302 and a customer device 308 associated with customer 106. The decision and routing logic rules engine 302 is also interfaced with interface 306. Interface 306 serves as an interface between the decision and routing logic rules engine 302 and a merchant device 310 associated with merchant 108. In some embodiments, customer device 308 may a laptop computer, desktop computer, a mobile device, a tablet computer or any other computing device capable of connecting to a public network such as the Internet. In other embodiments, customer device 308 is a mobile phone with one or more methods of connectivity that include but are not limited to SMS, Wi-Fi, 3G, 4G/LTE and Bluetooth. In some embodiments, merchant device 310 may a laptop computer, desktop computer, a mobile device, a tablet computer or any other computing device capable of connecting to a public network such as the Internet. In other embodiments, merchant device 310 is a mobile phone with one or more methods of connectivity that include but are not limited to SMS, Wi-Fi, 3G, 4G/LTE and Bluetooth. In some embodiments, customer device 308 may run a software application that allows the customer device 308 to communicate with communication engine 104. In some embodiments, merchant device 310 may run a software application that allows the merchant device 310 to communicate with communication engine 104.

In some embodiments, merchant 108 may have in place a rewards program. For example, the merchant 108 may offer customer rewards in the form of cash back or rewards points to a customer, wherein the customer rewards are calculated, for example, based on the purchase amount of the customer. In one embodiment, the customer rewards may be provided based on purchases in brick-and-mortar stores. In this embodiment, one method of providing the customer with a customer reward is by the merchant 108 handing out a token 802 to the customer 106 after a purchase transaction is completed. In some embodiments, token 802 may be a piece of paper which is pre-charged with a specific rewards amount (for example, a dollar amount or a specific number of rewards points or a certain number of miles). The token 802 may have an encrypted code, which may be implemented as any combination of printed alphanumeric characters, a bar code, Quick Response (QR) codes and so on. In other embodiments, the token 802 may be comprised of plastic, and the token 802 may have embedded within it a smart chip or RFID technology that allows the rewards information, for example, to be embedded within the token 802. In still other embodiments, a token 802 can be printed on-the-fly by merchant 108 via a computer printer or cash register, for example.

In some embodiments, token 802 is a single-use token, wherein the token 802 has no value after it has been used or redeemed. In other embodiments, token 802 may have an expiration date, wherein the token has no value after the expiration date. In still other embodiments, token 802 may progressively reduce in value over time until it reaches a zero value, after which the token 802 has no value.

In some embodiments, merchant 108 may offer goods and/or services to customer 106 via an online store. In these embodiments, merchant 108 may offer token 802 as an electronic token to customer 106, wherein the electronic token may be in the form of an alphanumeric code.

In some embodiments, the merchant 108 hands a token 802 to the customer 106, and it is the responsibility of the customer 106 to claim that Token to get the benefits associated with the token 802. This situation does not require the customer 106 to have checked-in, as this is a late-binding scenario. Here, the customer 106 takes the token 802 and at his or her convenience, sends an SMS message to the communication engine 104 which includes the token code from customer device 308. This may occur at a later point in time. Communication engine 104 authenticates the token 802 and associates it with the merchant 108 and the customer 106, updates the appropriate service database with the award corresponding to the benefits associated with the token 802, and also updates the balance. Communication engine 104 also confirms and notifies the customer 106 with the updated balance via another message sent to the customer device 308. In some embodiments, it is not necessary to send a notification to the merchant 108, as the processing of token 802 is asynchronous and without any check-in.

Encryption and fraud prevention is an important aspect in assigning an identifier to token 802. Some embodiments use methods to implement an identifier to token 802 that is a string of alphanumeric characters that contains some kind of non-repeated, unique value (such as a sequence number, or batch number), along with a “type” field if it is necessary to tell one token apart from another. An alphanumeric string can also have a field for some degree of error checking or redundancy, such as a CRC checksum. Finally, all these fields may be scrambled/encrypted with a mechanism so that reverse unscrambling/decryption is possible in a deterministic way.

Handing out a token 802 by merchant 108 to customer 106 has the advantage that by doing so, the customer 106 now has the responsibility of redeeming the reward, rather than this responsibility resting with the merchant 108. This is of huge benefit to a business because the merchant 108 can become a bottleneck during peak shopping periods, and the use of tokens such as 802 frees the merchant to process more normal transactions, while still continuing to give out tokens such as 802 (which takes only a fraction of the time to do compared to processing information via a mobile application, for example).

Due to the monetary value associated with a token such as 802, it can be tempting for fraudsters to decipher the code or try to cheat the system in various ways. The following are some ways to deter and detect user behavior that could potentially be fraudulent, and perhaps block such users until additional information is obtained to clear them:
Too many claims from one person, over a specified time period, perhaps for tokens from the same merchant.
Claims for Tokens that have never been activated.
Claims for Tokens that have never been manufactured.
Too many Tokens claims that turn out to be invalid.

This is not a comprehensive list, but since the customer's identity (e.g. phone number) has to be revealed while claiming a token, it makes it possible to at least trace the individual in case of real fraud.

In some embodiments, tokens can perform different functions, some of which are listed below:

1. Cash Back Tokens: This is the mechanism by which a merchant gives the cash back reward to the customer and then the customer claims the token to get the cash back value of the token. This loyalty reward money accumulates in the customer's loyalty account and can be withdrawn by the customer as he or she pleases, or can also be used for new purchases, via in-store redemptions, for example.

2. Enrollment Tokens: These are tokens that are provided as an incentive for customers to join a customer rewards program. This can be looked upon as a welcome bonus. A token of this type can only be claimed once as its purpose is new enrollment, and once enrolled, the customer is ineligible for double enrollments.

3. Community Gift Cards: These are implemented using the token technology, even though they are called gift cards. In some embodiments, the funds for the gift cards are also maintained and tracked separately and not co-mingled with the cash back or enrollment bonus funds, for example.

In other embodiments, a token can be categorized based on a set of rules, examples of which are described below.

i) Single-Use Token v/s Multi-Use Token (one Token used only once for any one customer; or one Token used only once by a given customer, but still useable by other new customers, etc.)

ii) Value

iii) Expiration Date

iv) Quantity (number of uses if Multi-Use)

v) Merchant association

vi) Community association

vii) Multiple Tiers of Value, Quantity and Expiration Dates (where the value of the Token changes/reduces after a given date to a different value, and does this again for multiple such steps)

viii) Service to invoke for the Token (in other words which account or fund to put the claimed value in; also can be looked upon as “color of money”—essentially, are these funds to be treated differently with special constraints)

ix) Actions to perform (also a part of the Service invoked, whereby there could be rewards or incentives for Customers, Merchants, Sales folks, Referrals etc. and these could be tied to the Category of Tokens)

x) Domino actions (also a part of the service invoked, whereby a referral reward cascade can be created by having someone send a token in to claim it, and the sender is sent another token in response to forward to others, which if claimed by the person this gets forwarded to, has the “DNA,” i.e., identity, of the original sender so that the original sender can be credited/rewarded for the referral; this cascade can be multi-level for multi-level incentives).

In some embodiments, tokens can be used to perform multiple functions, examples of which follow.

a. First-time use: Detect that a customer may have been to a merchant for the first time, so if there is a special incentive for that, it can be given.

b. One-time use constraint: There could be a token type that someone can use only once in a lifetime or within a certain period, so this can be constrained.

c. Changing Value over Time or Quantity or both: A token may have a time-incentive to use it quickly, whereby it rewards a high value, but after a certain date (or a quantity limit is reached), that value reduces, and after even more time (or reaching a new quantity limit), reduces even more and so on.

d. Partnership Tokens: Tokens that detect that two stores, or a small set of stores are partners and that this token is a part of that family of stores, and hence gives a different reward Value.

e. Referral Tokens: A token when claimed results in a new token code being issued to the sender to forward to others, so that further, cascaded referrals are tracked via the token chain. The referral tokens can work with both a pure SMS environment as well as a hybrid SMS and Internet environment.

f. Coupons: Tokens also have a use as discount coupons. The difference is that a discount is given during the point-of-sale transaction (POS) where the price paid by the customer is reduced, while cash-back is the rebate that gets done after having paid the full price for the goods/services. In case of tokens, the communication engine 104 actually credits and debits the customer and merchant accounts respectively to transfer funds, however, for the category of coupons, the communication engine 104 does not transfer funds, but simply authenticates the code on this kind of token which is called a coupon. From a technology perspective, tokens and coupons are similar; however, how they get used and perceived can be widely different. Discount coupons are used universally and both customers and merchants like the instant gratification of paying less. However, merchants ideally want to target and even limit certain high discounts with specific constraints (e.g. to a specific customer only, or for a specific item, or on a date or time etc.). In some embodiments, tokens can also function as Coupons. Essentially, a merchant can inform (via SMS, an App or email campaign) a customer of a special coupon that may be only available to that customer and for a one-time use only (which means the same coupon given to another person would not be usable; this is typically done to promote loyalty). A coupon like this can simply be texted to the communication engine 104 when the customer is shopping at a merchant location. The communication engine 104 recognizes that it is a code for a coupon, and then optionally sends an SMS to the merchant with an authorization code (and also sends an SMS to the customer with a confirmation). The merchant knows that the customer and code are authenticated, and can reduce the price (essentially give the discount) at the POS transaction. Since, the customer paid less, the coupon's effect is immediate, but no money is actually moved between the merchant and customer accounts. Unlike paper coupons that people cut out of newspapers etc., the coupon code provides all the sophisticated tracking and data analytics of the customer that the merchant values. Also, unlike many coupons that get used via phone apps these days, this coupon can be used via SMS or in a hybrid case, through a combination of SMS and phones.

FIG. 8B represents a flow diagram depicting an embodiment of a method 804 for managing tokens as a part of a rewards program. At 806, a merchant obtains unactivated tokens associated with a rewards program. In some embodiments, the unactivated tokens may be a stack of blank, unassigned token cards that may be available for purchase by the merchant in a department store, for example. In other embodiments, unactivated tokens can be provided to the merchant by, for example, a personnel associated with the service provided by communication engine 104. At 808, the merchant registers and activates the tokens, assigning a specific monetary value to each token. In some embodiments, the process of activating the tokens can be done by the merchant calling a phone number and following the directions given over the phone. In other embodiments, the merchant can visit a specific website in order to activate the tokens. In still other embodiments, a merchant may be provided with fully activated tokens with one or more specific values associated with the tokens by, for example, personnel associated with the service provided by communication engine 104. At this point in time, each activated token is now “bound” with two things: i) Value, as a certain amount of money or points is/are now associated with it, and ii) the merchant, and the identity of the merchant. Next, at 810, a customer purchases a good or service from the merchant. At 812, the merchant checks to see if the purchase qualifies for a loyalty reward. If the purchase does not qualify for a loyalty reward, then the method terminates at 814. If the purchase does qualify for a loyalty reward, then at 816 the merchant gives a token to the customer as a loyalty reward. In some embodiments, the token may have a cash redemption value. In other embodiments, the token may represent a certain number of reward points or reward miles. Finally, at 818, the customer claims the loyalty reward by redeeming the token as per the rules of the rewards program.

In some embodiments, the token contains an encoded alphanumeric string to uniquely identify the merchant that gave the token, and it also can identify the value of the token (in cases where the token does not have any intrinsic shape/color coding and is a generic token that can have a flexible, unassigned value). The customer is expected to provide this alphanumeric string to the communication engine through some mechanism that establishes the identity (e.g. mobile phone, web-application, email, Facebook/Google ID, etc.) of the customer. The key mechanisms for claiming rewards from Tokens are:

i) Website Login: The customer may login as himself/herself and type the token number.

ii) Mobile Phone App: The customer may use an app on the mobile phone and type the token number, or scan the bar code or Quick Response code of the token number.

iii) Texting/SMS: The customer may text (or send an SMS to) a specified phone number with the token number. This method has the advantage that it can be done by customers who do not necessarily have a smartphone or web access. It also helps customers that have limited capabilities with using devices, for example those who are capable of only performing simple operations such as making a call or sending text messages. An additional advantage of this mechanism is that customer does not part with their mobile phone number explicitly, but rather, the mobile number is automatically sent to the receiving end in the process of sending the text. This overcomes some of the reservations that customers may have about providing personal data such as phone numbers.

If the customer never claims his or her loyalty reward, that reward and its associated token essentially go waste; the value of money or points on the token is unrealized. However, it should be noted, that if so desired, it is possible to refund the unclaimed token value to the merchant that purchased it. If the customer does claim his or her loyalty reward, then the token is now bound to the customer's identity (e.g., his or her phone number and potentially other information such as email, zip code and so on). The token at this point is associated with a value, the merchant and the customer.

The use of tokens can provide useful information to the merchant and the entity issuing the tokens about the shopping habits of a customer, for example. However, since the claim process by the customer may happen immediately or after several hours, days or even weeks, it is ordinarily not possible to pin down the exact date and time of the purchase transaction (since the ordinary token does not contain a date/time stamp of any kind; but, to be precise, tokens can be purchased and activated in batches, and based on the time of the activation, a lower bound can be put on the date of tokens). However, if this is a reasonably busy merchant with lots of purchase transactions with multiple customers, it may be possible to infer and narrow down the duration within which the transaction may have occurred. The way this is achieved is through the fact that in some embodiments, the tokens may be stacked in sequence (or may be given out in the form of “stickers” which are on a rolling tape, or in a tear-off roll such as used for raffle tickets, which ensures an in-order delivery). In this case, the merchant may give out tokens with an increasing sequence number. If there are many customers getting these tokens, the probability increases where at least some customer decides to immediately redeem the token they had been given (perhaps within seconds, on their mobile phone). This immediately helps bound the time period when all tokens with an earlier sequence number were distributed. By continually doing this for all claimed tokens for a given merchant, it is possible to narrow down to hours (and potentially even minutes) the time (and date) of when a transaction occurred. So, even though this process is not fully deterministic, in a realistic case of a merchant with reasonable traffic, it is possible to capture a reasonably accurate picture of the complete transaction of a customer with a merchant for data analytics and tracking purposes by using the lower and upper bounds on the time of a customer's transaction by looking at the times of claims of other customers that may have come before or after the customer using the token sequence numbers. It should be noted however, that the number on the token may not reveal the sequence number information in a human readable form to the observer as the card may have been encrypted, and only the entity issuing the token would be able to de-encrypt and decipher this information.

Some embodiments may also feature a multi-merchant time-stamping algorithm, which derives extra information from the time-stamps of multiple merchants. For example, if one customer who is in the habit of promptly claiming his/her tokens happens to get tokens from a few different merchants and claims them immediately, that helps immediately establish a time-bound of a per-merchant sequence number for all of these merchants. So, this works even when a specific merchant does not have a statistically large number of customers, but just a few itinerant ones, who may be prompt in claiming.

Once a token is claimed, the entity issuing the token can associate the merchant, value and customer information, and can also associate a range of transaction amount and bound the time and date. Some very valuable metrics can then be presented back to the merchant which include but are not limited to:
Claim Ratio: The claim ratio of the distributed tokens is easily measurable. If the tokens have a high value, it is likely that a very large number of them will get claimed. If they are low in value, customers may not bother to claim them. The claim ratio indicates to the merchant how much their reward is being valued.
Claim Rate: One can measure how quickly a token gets claimed after the token is issued. If the claim rate is high, that is a good sign and indicates that the customers are active and care about the rewards.
Other Stores: Which other stores participating the cash back rewards program were shopped at by the customer within a given time window can indicate both the source/path of the incoming traffic to the store, as well as path of the outgoing traffic from the store. This information can be used for further tuning the offers to customers to get more to visits the store.
Popularity: Which stores were most shopped at or which cash back offers were the most popular.

One of the benefits of monitoring the variables described above such as claim ratio and claim rate is that one can do dynamic pricing on the purchase price of tokens. Tokens cost money to buy from the merchant's perspective. If a merchant picks up an unassigned box of tokens at a store shelf and pay for it, they are only paying for the cost of material. However, when they “fill” the token with a value, they are paying the full value for the box of tokens. For example, if a merchant fills a box of 100 tokens with a value of $0.25, then he or she would have paid $25 (not counting any service fee). However, in actual situations, the merchant may give out these 100 tokens, but perhaps only 60 of the tokens get claimed by the customers, while the rest are not used. Some embodiments might implement a way of looking at the exact claimed tokens of any denomination and then when the merchant returns to fill and activate a new batch of tokens, the embodiment can have a “dynamic” pricing, whereby the merchant is not charged full price, but a lower rate based on the past claim ratio for a given denomination of tokens. So, this new batch of 100 Tokens may only cost the merchant $25×60% or $15. This value can also be adjusted over time. So, let us say the next month, the claim ratio is higher, the new purchase can accommodate that and essentially treat it as pay-per-claim and also factor that in for averaged future dynamic pricing. This ability makes it a very fair deal for the merchant as he knows that he or she will never have to pay more than the value he actually realized through actual measured claims from his or her customers.

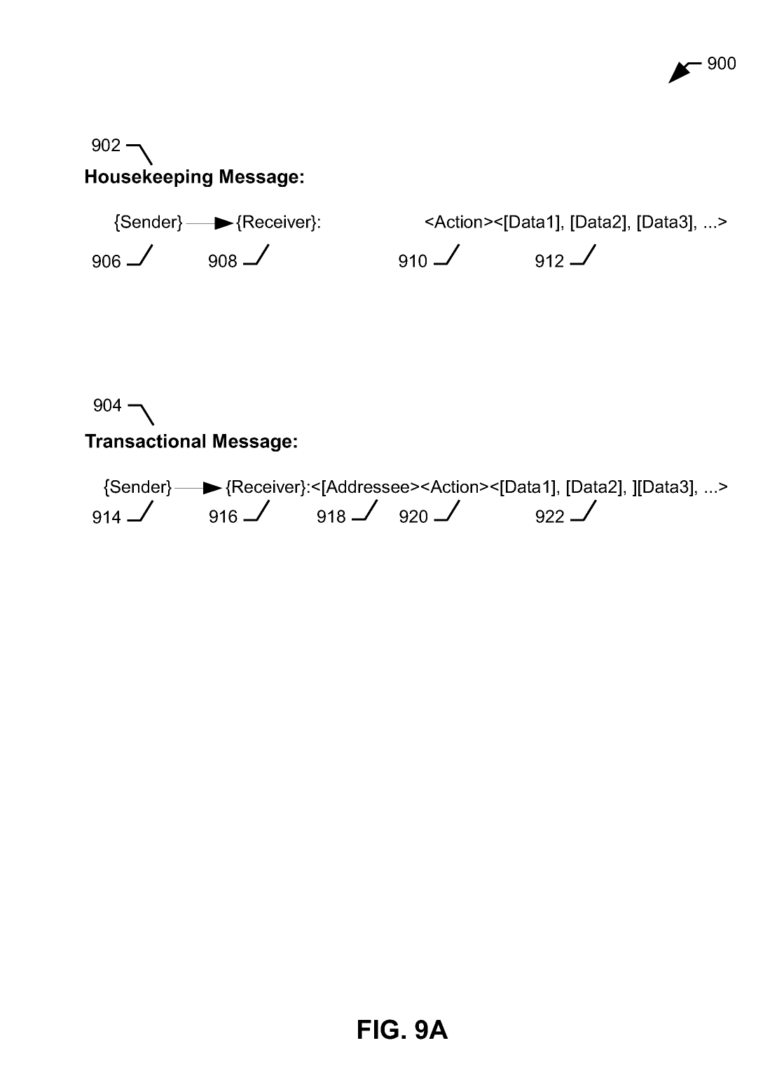

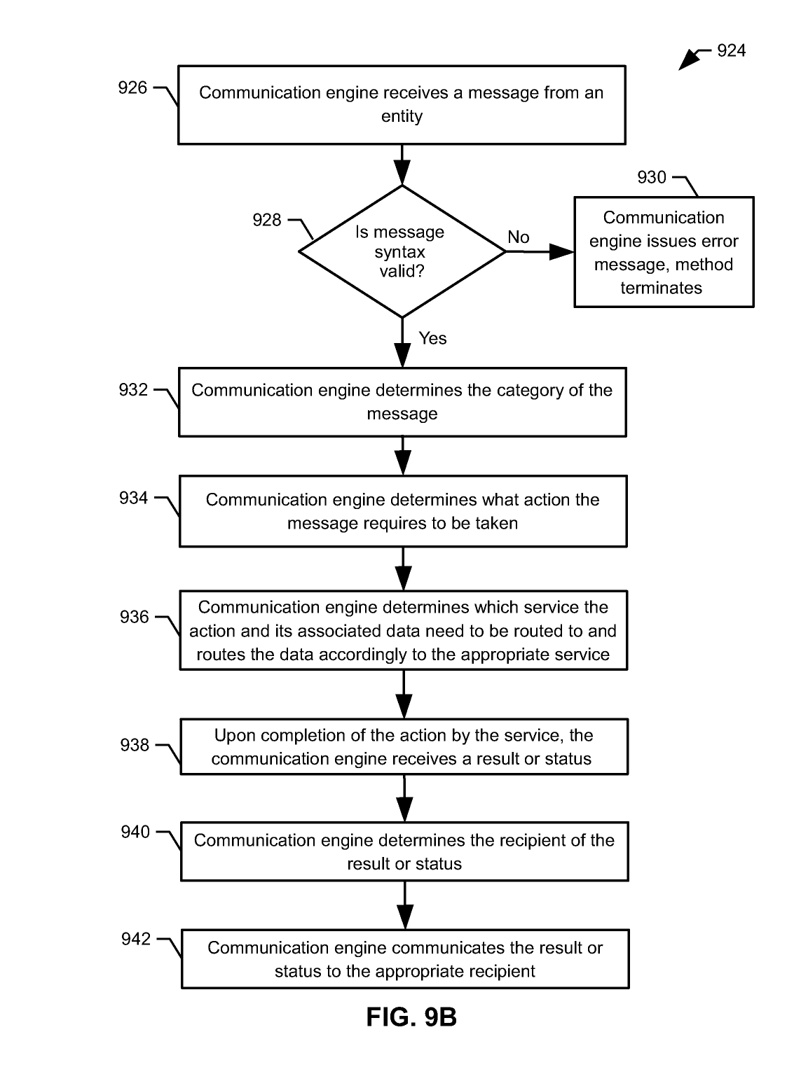

FIG. 9A is a diagram 900 depicting example SMS message structures and syntax used to communicate with a communication engine. In some embodiments, an SMS message as transmitted from a customer to a communication engine, from a communication engine to a customer, from a merchant to a communication engine or from a communication engine to a merchant, can either be a housekeeping message 902, or a transactional message 904. Housekeeping message 902 comprises sender information 906, receiver information 908, action 910, and a data payload 912. Transactional message 904 comprises sender information 914, receiver information 916, addressee field 918, action 920 and a data payload 922. Action 910 associated with the housekeeping message 902 can be one of: Help, Balance, Password Maintenance, Profile Update, Text Forwarding, Transferring Account Amounts, Notifications, Responses, Informational Messages, Warnings etc., along with optional or required data as appropriate. Addressee 918 is the party that the communication engine 104 is supposed to relay the information to. An example of the addressee field 918 is a merchant symbol discussed earlier in this specification, which is what the customer uses to send a text that is intended for a merchant. But, how does a merchant send something back to a customer? Essentially, when a customer checks-in, the communication engine generates an alias identity for the customer, also known as a customer session ID. This customer session ID is provided by the communication engine to the merchant. The customer session ID is a short string that serves as an address of the customer for a short period of time. So, when the merchant uses this customer session ID as the addressee field 918, the text message is sent to the correct customer. Since the customer session ID is a temporary identity and corresponds to a session with the merchant, the length of the customer session ID can be very short, and yet allow the merchant to send messages to the customer without the customer or merchant knowing the mobile phone number of the other party.

Action 920 represents something that is being requested of the addressee represented by the addressee field 918. Examples of action 920 include but are not limited to paying some amount, redeeming an amount, canceling something and so on.

There can be multiple data items in data payload 912 or data payload 922, which can be in sequence in a comma separated list so that they can be delineated, or in some cases may be automatically classifiable due to their context. Examples of these include amounts, status or other transaction information.

In one example, a customer goes into a merchant to shop and decides to engage in a transaction with the merchant where financial information is exchanged between them in the store via their mobile devices using SMS/Texting, both connected to the communication engine 104 (via a phone number or short code available for SMS/texting for the service), but without either party divulging their personal mobile phone numbers. In order to conduct transactions, one or more of the following steps may be necessary:

1. Merchant transfers “data” to the customer: The term “data” here refers to a small packet of information that fits in a small SMS message, which can be a value or a phrase etc. For example, this could be a cash-back reward for shopping. Two steps are needed for this to happen:

a. Check-in: The customer needs to “check-in” into the store, which is equivalent to saying that he announces his presence at the store or opens a connection with the merchant. Since merchant Symbols are publicly posted and available, the customer can initiate a connection with any merchant. This is done by the customer sending an SMS to the communication engine 104 with a session request along with the merchant identifier.

b. Merchant transfers data to the customer: The merchant now knows how to connect to this customer (via the communication engine 104), as the customer has checked-in and a connection has been established. So, now he or she can initiate the transfer of data (i.e. funds/rewards/points) via this opened connection. The merchant uses an SMS to the communication engine 104 to get the transfer directed to this checked-in customer. The communication engine 104 directs the SMS from the Merchant to this checked-in customer since the session is already established.

2. Customer Transfers “data” to the merchant: In this case, the “data” that the customer sends could be a payment for something or an e-gift certificate to redeem, in the form of a small SMS text string. A check-in is not needed prior to this transfer. Since the merchant identifier is known, the customer can directly address the specific merchant by sending an SMS to the communication engine 104 and including the merchant identifier for routing, along with the other information content for payment, for example.

3. Housekeeping Interchanges: Aside from transactions between the customer and the merchant, there could be basic transfers of data between the customer and the communication engine 104, or between the merchant and the communication engine 104. For example, this can include maintenance functions such as help, login, profile update, balance check, etc. Another example of maintenance functions is “text forwarding”, whereby one can change the association of which mobile number gets a text message at any given time, just the way “call forwarding” works on phones and pbx switches. Similarly, account balances can also be forwarded or in essence re-gifted to another person by requesting such a transfer via the communication engine 104. A third example is financial transactions that do not involve direct exchange of messages between the customer and merchant; the customer may register a rebate token, or an e-gift certificate with the cloud service, or request a transfer of funds to his/her bank account. These are basically SMS messages sent by either the customer (or merchant) to the communication engine 104 with a request for some action, resulting in an appropriate response back from the service with the requested data or confirmation of action requested.

Letting a customer address their SMS to the merchant while using the merchant symbol as the address via the communication engine is made possible by the fact that the merchant symbol can be publicly posted. For the merchant to send an SMS back to the customer, requires the merchant to have an address to send the SMS as well. Since the customer's mobile phone number or other identity cannot be published, this is accomplished via a temporary address, which is called a customer session ID (CSID). The customer session ID corresponds to an alias identity. When the customer checks in, the communication engine creates a session and informs the merchant the CSID that can be used to address this customer. The CSID can be a fairly small alphanumeric string, making it very easy to address the already checked-in customer. Also, the CSID is a temporary address, valid for a specified or default duration, after which it expires. Here are a few characteristics of a CSID:
CSID Timeout: For a normal situation, one could assume that the CSID can be valid for several minutes, say 10 minutes, or even 30 minutes. Of course, it cannot be forever, as it is a temporary ID, so that the short address can be reused. During this time, if the merchant has not responded to it, it expires, and the customer has to re-checkin.
CSID Alphanumeric String: The CSID is a temporary string that identifies the customer that has been paired with the merchant. In the very simplest case, when at most one customer is allowed to be paired with a merchant at any time, this string could indeed be a null string, because there is one and only one customer, and any message that is sent by the merchant intended for that customer will only go to that customer. However, for situations that have back-to-back customers, and in order to ensure that right at the transition of the timeout, one customer's message is not sent to a different customer, it is desirable to have at least a short string to designate a customer. So, one could use something as simple as C1, C2, C3 . . . C9 and then rotate back to C1 after the last one. This way each message is explicitly addressed and never goes to the wrong customer and always reaches the intended customer. It makes sense to keep the strings as short as possible, since the number of characters on an SMS message is limited. Another consideration for the string naming is to not make it too structured like the C1, C2 . . . C9 example above as there could be a small risk of a typo (or autocorrect on the mobile phones) resulting in the message getting sent somewhere else. To prevent this, one could use a random multi-character alphanumeric sequence (e.g. XB, 2N, CY3 etc.).
Multiple Simultaneous CSIDs: If multiple customers line up in a store with a merchant and all try to check in either simultaneously or in quick succession, there needs to be a mechanism to make sure that the messages are associated correctly if the merchant responds. Here, unique CSIDs can be issued for each customer, and the merchant can address the messages to any specific customer by using that customer's CSID. These CSIDs do not have to be serviced in a queue sequence and can indeed by serviced out of sequence. But how does the merchant tell from the message texted to him by the service which CSID belongs to which customer? There are multiple mechanisms that can be used: i) The same CSID can be texted to both the customer and merchant, and then the merchant can call the customer out by CSID in the store to associate correctly, or ii). The Merchant can be sent not just a CSID but also a short string that is derived from the customer's credentials, which is likely to be unique (e.g. for a customer called John Smith with a phone number 408-555-1234, it could be a string: John1234). The second approach has the advantage of providing a name to address the customer, but uses up space on the short SMS message, while the first approach is most economical on the message length. There can also be infrequent situations where a customer erroneously checks into a store via SMS that he is not currently shopping at, and a verbal confirmation of the CSID between the Merchant and the customer confirms the pairing. Note that some simpler merchants may not want to handle multiple simultaneous check-ins and in that case, the communication engine may reject new requests asking them to retry as the merchant is busy currently.

FIG. 9B represents a flow diagram depicting an embodiment of a method 924 for processing messages received by a communication engine. In some embodiments, at 926 a communication engine receives a message from an entity, wherein the entity may be for example, a user or a merchant. In other embodiments, the communication engine may receive the message via a communication method that includes but is not limited to SMS, the Internet, Wi-Fi, 3G, 4G/LTE and so on. At 928 the method checks to see if the message syntax is valid. If the message syntax is not valid, the communication engine issues an error message at 930, and the method terminates. If the message syntax is valid, then at 932 the communication engine determines the category of the message. For example, the message could be a check-in request, a redemption request, a token request and so on. Next, at 934, the communication engine determines that action the message requires to be taken. Next, at 936, the communication engine determines which service the action and its associated data need to be routed to and routes the data accordingly to the appropriate service. At 938, the communication engine receives a result or status upon the completion of the action by the service. At 940, the communication engine determines the recipient of the result or status. Finally, at 942, the communication engine communicates the result or status to the appropriate recipient.

In some embodiments, the architecture of the communication engine is designed to handle a very large number (potentially in the tens of thousands or more) of requests/messages passing through it simultaneously. Each request is independent and messages may originate from any port and terminate on any port, with the total system throughput being limited by what the telecom carrier can handle on its incoming and outgoing ports.

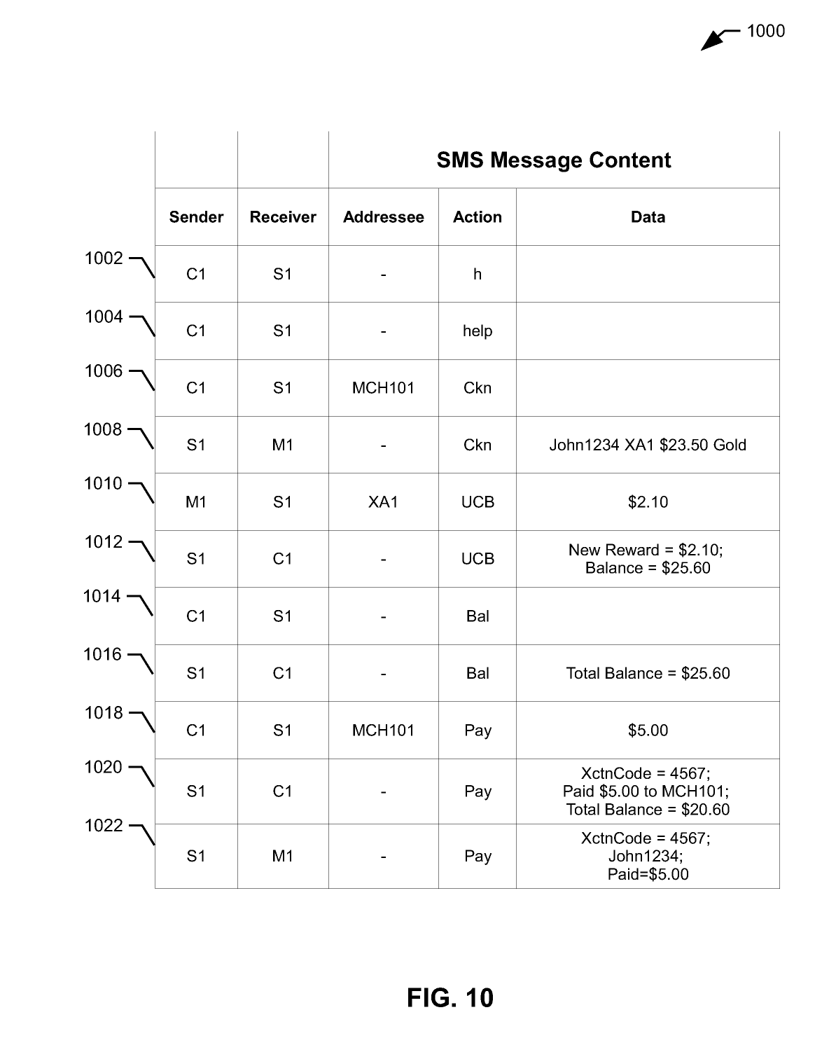

FIG. 10 is a diagram 1000 presenting example SMS-based interactions between a communication engine and a customer, and between the communication engine and a merchant. In these examples, Cl refers to a customer, Ml refers to a merchant and S1 refers to a service provided by or associated with a communication engine.

1002 is an example of a housekeeping message 902, wherein the sender 906 is C1, the receiver 908 is S1, and the action 910 is “h”, wherein “h” is used to signify a help request.

1004 is an example of a housekeeping message 902, wherein the sender 906 is C1, the receiver 908 is S1, and the action 910 is “help”, wherein “help” is used to signify a help request.

1006 represents a transactional message 904, wherein the sender 914 is C1, the receiver 916 is S1, and the addressee 918 is MCH101, where MCH101 is an alphanumeric identifier associated with Ml. The transactional message represented by 1006 is a check-in request to a merchant with a symbol MCH101

1008 represents a transactional message 904, wherein the sender 914 is S1, the receiver 916 is M1, and the data payload 922 is “John1234 XA1 $23.50 Gold.” Using the transactional message represented by 1008, the communication engine informs the merchant, Ml (as the communication engine knows that MCH101 is the public name for Ml) that a customer with a name John and with a CSID=XA1 has checked-in and has a loyalty reward balance of $23.50, and has achieved Gold tier status.

1010 represents a transactional message wherein the sender 914 is M1, the receiver 916 is S1, the addressee 918 is XA1 (the alias identity for C1), the action 920 is “UCB,” and the data payload 922 is $2.10. By this message represented by 1010, M1 gives C1 associated with CSID=XA1 a Universal Cash Back (UCB) of $2.10 via S1.

1012 represents a transactional message 904 wherein the sender 914 is S1, the receiver 916 is C1, the action 920 is “UCB,” and the data payload 922 is “New Reward=$2.10; Total Balance=$25.60.” By this message represented by 1012, S1 informs the C1 that he or she has received a UCB reward of $2.10 and his or her balance has now increased to $25.60.

1014 represents a bookkeeping message 902 wherein the sender 906 is C1, the receiver 908 is S1, and the action 910 is “Bal.” With this message represented by 1014, C1 wishes to inquire with S1 about their UCB balance.

1016 represents a bookkeeping message 902 wherein the sender 906 is S1, the receiver 908 is C1, the action 910 is “Bal,” and the data payload 912 is “Total Balance=$25.60.” With this message represented by 1016, S1 communicates C1's UCB balance to C1.

1018 represents a transactional message 904 wherein the sender 914 is C1, the receiver 916 is S1, the addressee 918 is MCH101, the action 920 is “Pay,” and the data payload is “$5.00.” The message represented by 1018 signifies that, S1 wants to use some of his balance as a payment for a new purchase and initiates an in-store-redemption request of $5.00.

1020 represents a transactional message 904 wherein the sender 914 is S1, the receiver 916 is C1, the action 920 is “Pay,” and the data payload 922 is “XctnCode=4567; Paid=$5.00 to MCH101; Total Balance=$20.60.” By this message represented by 1020, S1 provides a transaction code to C1 (which needs to match the code sent to the M1) and since $5.00 was paid, updates the UCB balance which is now down to $20.60.

1022 represents a transactional message 904 wherein the sender 914 is S1, the receiver 916 is M1, the action 920 is “Pay,” and the data payload is “XctnCode=4567; John1234 Paid=$5.00.” With the message represented by 1022, S1 also informs M1 that C1 with the name John paid $5.00 from his loyalty reward towards a purchase and it has a Transaction Code of 4567, which ought to match the one texted to the C1, which M1 and C1 can verbally confirm.

The example represented by 1000 shows a customer loyalty situation where a merchant gives a cash-back reward, called a Universal Cash Back (UCB), to a customer, and the customer can redeem or use that reward to pay for new purchases later.

The SMS/Texting based transaction architecture is very general, however, and can be applied to other situations as well. For example, instead of cash-back rewards, these rewards could be reward points that can be given and redeemed via SMS messages. These could also be travel miles that can be given and redeemed via SMS messages. Another situation could be Coupons, Discounts, Deal or Offers that can be sent via SMS by merchants and claimed or redeemed by customers by using SMS messaging. Yet another novel use can be that of referrals or referral bonuses. In this case, a merchant may have offered a reward for the purchase of a specific item or service. This may have come to the first customer, C1 as an SMS offer in a message. But, the merchant may have also offered a referral bonus to a person who forwards that offer to someone else. Here, the above architecture and approach allows that forwarding process to be done in a very unique way using SMS messaging. The customer, C1, may know the mobile number of their friend, say, a customer, C2, and can connect to the communication engine to forward (or specifically refer) the deal or offer to C2. The communication engine now can create a derived offer code that gets sent to C2, while also registering the fact that C1 referred C2. C2 can then connect to the merchant to take advantage of the offer, with all of these transactions happening via SMS.

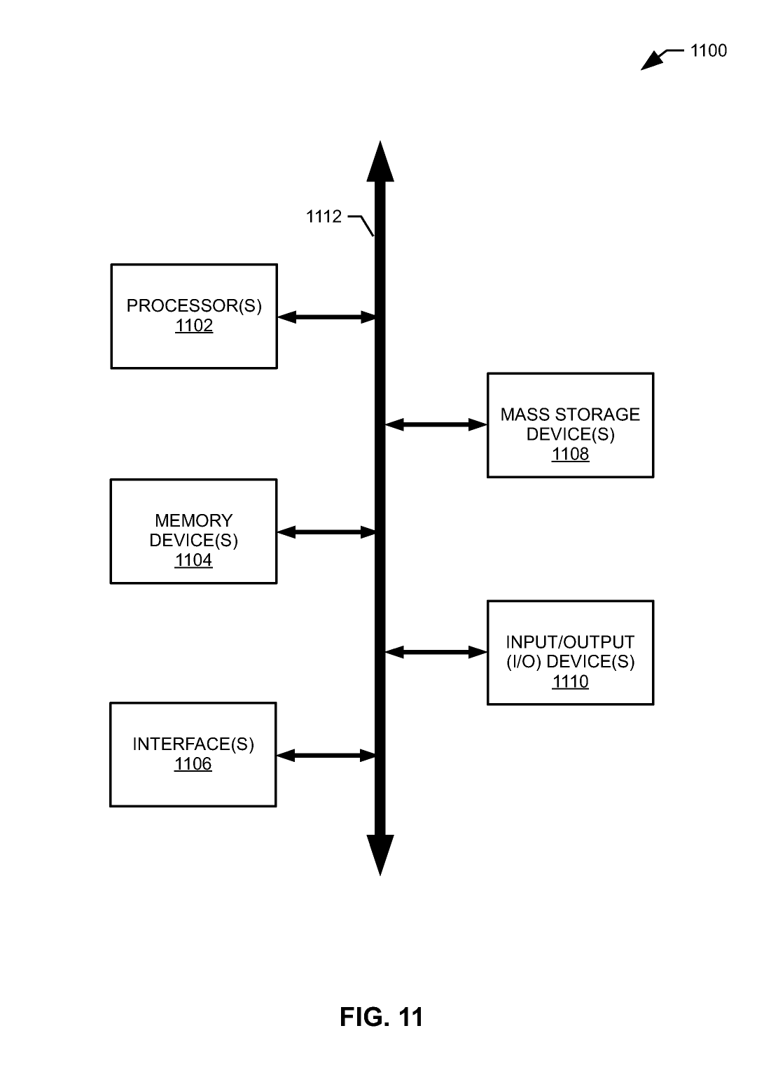

FIG. 11 is a block diagram 1100 that depicts a generalized processing architecture that can be used to implement the communication engine and other systems and components discussed herein. Embodiments of the present invention can be implemented using a generalized processing architecture that includes one or more processors 1102, one or more memory devices 1104, one or more interfaces 1106, one or more mass storage devices 1108, and one or more input/output devices 1110, wherein all the different components that comprise the system are interfaced via a centralized bus 1112.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving, from a user, a first SMS message;
extracting from the first SMS message, using one or more processors, a user identity corresponding to the user and a transaction request;
assigning, using the one or more processors, an alias identity corresponding to the user identity;
transmitting, to a merchant device, a second SMS message that includes the alias identity and the transaction request;
receiving, from the merchant device, a third SMS message that includes the alias identity and a transaction completion confirmation;
extracting from the third SMS message, using the one or more processors, the alias identity and the transaction completion confirmation; and
transmitting to the user a fourth SMS message that includes the transaction completion confirmation based on the user identity.

2. The method of claim 1, wherein the transaction request is associated with one of a financial transaction or a reward.

3. The method of claim 2, wherein the financial transaction is associated with a rewards program.

4. The method of claim 1, wherein the transaction request is associated with one of a non-financial transaction or a reward.

5. The method of claim 1, wherein the user is a customer of a merchant associated with the merchant device.

6. The method of claim 1, wherein the merchant device is associated with a retail merchant.

7. The method of claim 6, wherein a symbol comprising alphanumeric characters identifies the retail merchant.

8. The method of claim 1, wherein the user identity is the user's mobile phone number.

9. The method of claim 1, wherein the user identity is not shared with the merchant device.

10. An apparatus comprising:
a first interface configured to receive, from a user, a first SMS message that includes a user identity and a transaction request;
a processor configured to extract from the first SMS message the user identity and the transaction request, assign an alias identity corresponding to the user identity, and construct a second SMS message that includes the alias identity and the transaction request;
a second interface configured to transmit, to a merchant device, the second SMS message and receive, from the merchant device, a third SMS message, wherein the third SMS message includes the alias identity and a transaction completion confirmation; and
the processor further configured to extract, from the third SMS message, the alias identity and the transaction completion information and transmit to the user a fourth SMS message that includes the transaction completion confirmation based on the user identity.

11. The apparatus of claim 10, further including a decision and routing logic rules engine configured to appropriately route received SMS messages to an intended recipient.

12. The apparatus of claim 10, further including a database configured to store user account information.

13. The apparatus of claim 10, further including a fraud detection and prevention module configured to detect and prevent any possible fraudulent activity.

14. The apparatus of claim 10, further including one or more service provider interfaces that provide services including at least one of cash back, cash back rewards, credit card points, airline mileage, reward points, discount coupons, deals, or offers.

15. The apparatus of claim 10, wherein the merchant device is associated with a retail merchant.

16. The apparatus of claim 15, wherein the retail merchant provides a physical token to the user, wherein the physical token is associated with a rewards program, wherein the physical token may be at least one of a cash back token, an enrollment token or a community gift card, and wherein the physical token may be associated with at least one of a specific value, an expiration date, a specific merchant, a specific customer, a specific community or a specific action.

17. The apparatus of claim 16, wherein the physical token corresponds to a customer reward.

18. The apparatus of claim 17, wherein the user has the option to claim the customer reward based on information associated with the physical token.

19. The apparatus of claim 18, wherein the user uses a customer device associated with the user and information associated with the physical token in order to claim the customer reward.

20. A method comprising:
receiving, from a user, a first message using a first communication protocol;
extracting from the first message, using one or more processors, a user identity corresponding to the user and a transaction request;
assigning, using the one or more processors, an alias identity corresponding to the user identity;
translating the alias identity and the transaction request into a second message associated with a second communication protocol associated with a merchant device;
transmitting, to the merchant device, the second message using the second communication protocol;
receiving, from the merchant device, a third message that includes the alias identity and a transaction completion confirmation, using the second communication protocol;
extracting from the third message, using the one or more processors, the alias identity and the transaction completion confirmation;
translating the transaction completion confirmation into a fourth message associated with the first communication protocol; and
transmitting to the user the fourth message based on the user identity, using the first communication protocol.

21. The method of claim 20, further comprising determining whether the syntax of the first message is consistent with a predetermined syntax.

22. The method of claim 20, further including identifying the first communication protocol and the second communication protocol.
